(19) United States
(12) Patent Application Publication
(10) Pub. No.: US 2012/0309578 A1
(43) Pub. Date: Dec. 6, 2012

(54) Arrangement For Driving A Vehicle Wheel With A Drive Motor

(75) Inventor: Ulrich Solka, Fuerstenzell (DE)

(73) Assignee: ZF Friedrichshafen AG, Friedrichshafen (DE)

(21) Appl. No.: 13/577,704

(22) PCT Filed: Dec. 17, 2010
(86) PCT No.: PCT/EP2010/070050

§ 371 Date: Aug. 8, 2012

(30) Foreign Application Priority Data
Feb. 10, 2010 (DE) 10 2010 001 750.7

(51) Int. Cl. B60K 17/04; B60K 7/00

(52) U.S. Cl. 475/149

(57) ABSTRACT

An arrangement for driving a vehicle wheel has at least one drive motor (2) which is integrated in a drive axle (1) of a vehicle and which is connected to a drive stage which is coupled with an output stage as output on the wheel hub side. A spur gear unit (3) is provided as drive stage and a planetary drive is provided as output stage.

### PRIORITY CLAIM

This is a U.S. national stage of application No. PCT/EP2010/070050, filed on 17 Dec. 2010. Priority is claimed on the following applications: Country: Germany, Application No.: 10 2010 001 750.7, Filed: 10 Feb. 2010, the content of which is incorporated herein by reference.

### FIELD OF THE INVENTION

The present invention is directed to an arrangement for driving a vehicle wheel having a drive motor integrated in a drive axle of a vehicle.

### BACKGROUND OF THE INVENTION

A wheel drive for a low floor bus having a drive motor arranged eccentric to the wheel axle is known, for example, from the publication DE 199 32 587 A1. The drive motor drives a toothed wheel of a reduction gear unit as drive stage in the form of a planetary gear unit. The driven toothed wheel is in meshing relationship with an outer central wheel on the one hand and, on the other hand, is in meshing relationship with additional tooled wheels which likewise engage with the outer central wheel. The output of this planetary gear unit is connected to an inner central wheel of a planet stage of the output stage whose planet carrier forms the output and is connected to the rim of the vehicle wheel to be driven.

Substantial installation space is needed in the known wheel drive arrangement due to the use of the outer central wheel and bearing housing for the intermediate gears in the drive stage. In order to increase the installed drive output, for example, it would be necessary to use correspondingly larger drive motors providing a greater drive output, which also increases the required installation space. In view of the fact that the available installation space at the drive axle is limited particularly by the wheel brake and wheel bearing and the vehicle design of the low floor bus, an increased output cannot be carried out because of the substantial installation space requirement in the known arrangement so that an additional drive axle is required for increasing output.

It is thus an object of the invention to provide an arrangement for driving a vehicle wheel having a drive motor integrated in a drive axle of a vehicle which requires the smallest possible installation space while delivering the same output.

### SUMMARY OF THE INVENTION

Accordingly, an arrangement is provided for driving a vehicle wheel having at least one drive motor which is integrated in a drive axle of a vehicle and which is connected to a drive stage which is coupled with an output stage as output on the wheel hub side, wherein a spur gear unit is provided as drive stage and a planetary drive is provided as output stage.

In this way, particularly due to the spur gear unit whose simple design results from eliminating the otherwise necessary ring gear and bearing housing for the intermediate gears, the required installation space is substantially reduced compared to known wheel drives so that free installation space is advantageously made available particularly in axial direction. This installation space can be used, for example, to install larger drive motors providing a higher drive output. Accordingly, the available installation space at the vehicle axle is sufficient to increase the drive output of the drive axle and therefore to economize on additional drive axles. Further, by using the planetary drive as output stage with the spur gear unit as drive stage, a desired high overall transmission ratio can also be realized in the wheel drive with the arrangement according to the invention.

Within the framework of one embodiment of the invention, a one-stage spur gear unit is preferably used, which spur gear unit is connected on the drive side to the output shaft of the drive motor and on the output side to a central drive shaft which is preferably arranged inside the wheel hub and which is used to drive the output stage on the wheel hub side. Other gear unit constructions providing a similar advantage with respect to installation space can also be used.

In another embodiment of the invention, a Wolfrom type gear unit or the like, for example, can be used as a planetary drive for realizing the desired overall transmission ratio within the framework of the output stage. For example, the sun wheel of the Wolfrom gear unit can preferably be connected to the drive shaft of the drive stage or of the spur gear unit. The Wolfrom gear unit comprises a plurality of double planets, for example, four or the like, the smaller step wheel of each double planet engaging with the sun wheel. The smaller step wheels of the double planets simultaneously mesh with a fixed ring gear. Each of the larger step wheels of the double planets engages as output with the wheel hub of the vehicle wheel to be driven.

In another embodiment of the invention, a multistage, e.g., two-stage, planetary gear unit can also be used as planetary drive. The sun wheel of the two-stage planetary gear unit can preferably be connected to the drive shaft of the drive stage or of the spur gear unit. The planet gears of the first stage of the planetary gear unit can mesh with the fixed ring gear; the planet carrier of the planet gears of the first stage is connected to the sun wheel of the second stage. The sun wheel of the second stage meshes with the planet gears of the second stage which in turn engage with the fixed ring gear. The planet carrier or the arm of the planet gears of the second stage is connected to the wheel hub of the vehicle wheel to be driven and accordingly forms the output.

In this embodiment, it can be provided, for example, that the planet carrier of the first stage and the sun wheel of the second stage form a common constructional unit. It is likewise possible that the planet carrier of the second stage forms a common constructional unit with the wheel hub. However, separate structural component parts or structural components comprising a plurality of parts which are then connected to one another in a corresponding manner can also be used.

Further, in the arrangement according to the invention, for example, a so-called Ravigneaux gear unit or the like can be used as output stage. Further, other gear unit variants realizing a correspondingly desired overall transmission ratio for the proposed wheel drive can also be used in the arrangement according to the invention.

The drive side and the driven side can be reversed in the instant arrangement.

The arrangement of the present invention can preferably be used for driving a vehicle wheel in a driven vehicle axle of a commercial vehicle such as, e.g., a bus or omnibus.

### BRIEF DESCRIPTION OF THE DRAWINGS

The present invention will be described in the following with reference to the accompanying drawings showing various embodiments of the arrangement according to the present invention. In the drawings:

FIG. 1 is a partial sectional view of a first embodiment of an arrangement according to the present invention;

FIG. 2 is a sectional view of a first embodiment of an output stage of the arrangement;

FIG. 3 is a sectional view along section line A-A according to FIG. 2; and

FIG. 4 is a sectional view of a second embodiment of an output stage of the arrangement according to the present invention.

### DETAILED DESCRIPTION OF THE PRESENTLY PREFERRED EMBODIMENTS

Various embodiments of an arrangement, according to the invention, for driving a vehicle wheel having at least one drive motor 2 integrated in a drive axle 1 of a vehicle such as a portal axle of a low-floor omnibus are shown by way of example in the drawings.

In this arrangement, regardless of the embodiment in question, the drive motor 2, preferably a single electric motor, is connected to a drive stage which is coupled with an output stage as output on the wheel hub side. According to the invention a spur gear unit 3 is provided as drive stage and a planetary drive is provided as output stage. In this way, the arrangement of the present invention requires the smallest possible installation space so that the existing installation space at the drive axle 1 can be used for higher-output drive motors 2. Therefore, the drive output of the driven vehicle axle can be increased so that an additional driven axle in the vehicle can be dispensed with if necessary.

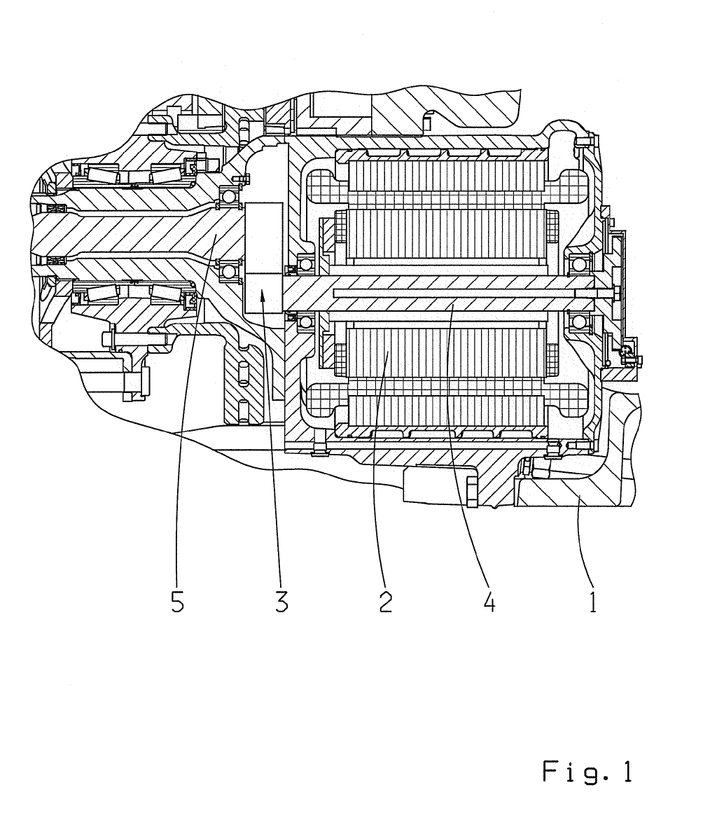

FIG. 1 shows a first embodiment of the arrangement in which the drive motor 2, preferably a single electric motor, is shown with the spur gear unit 3, e.g., a one-stage spur gear unit 3, as a drive stage. The spur gear unit 3 is driven by the output shaft 4 of the drive motor 2 and is connected on the output side to a central drive shaft 5 which is in turn coupled with the output stage, not shown more fully in FIG. 1, as output on the wheel hub side. The spur gear unit 3 comprises two spur gears. Each spur gear is rotatably supported on a shaft. The shaft or the spur gear is supported by bearings in such a way that one side of the spur gear is free and has no bearing so that axial installation space is reduced. As can be seen from FIG. 1, the single drive motor is disposed at an axial distance with respect to the rotational axis of the vehicle, and the rotational axis of the output shaft 4 of the drive motor 2, in the assembled condition, is located between the rotational axis of the central drive shaft 5 and the longitudinal axis of the drive axle 1,

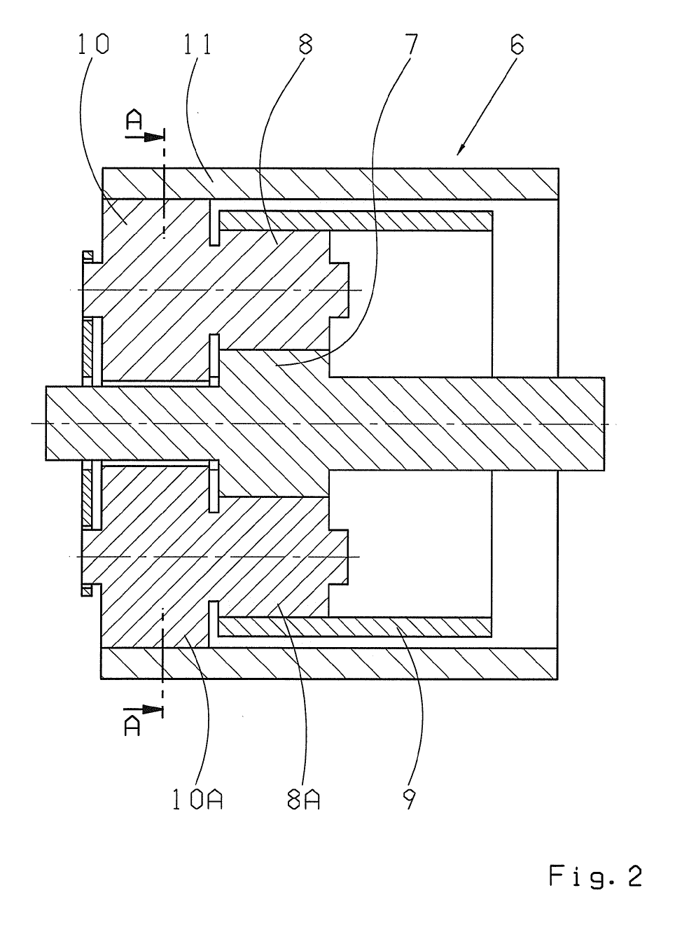

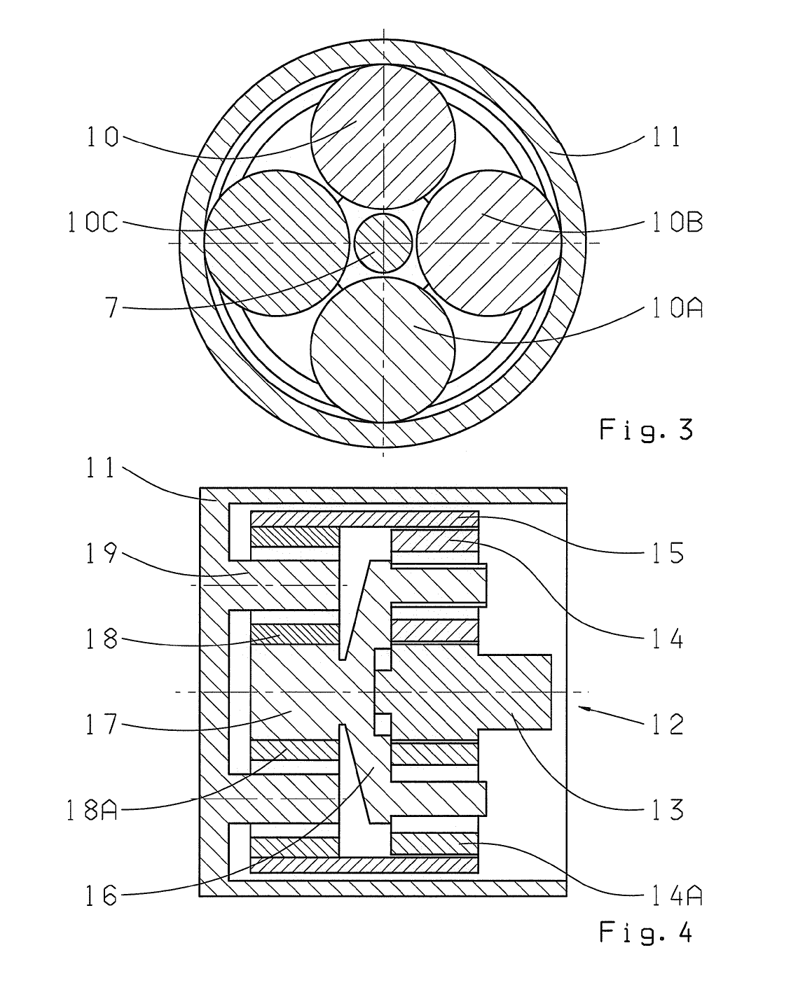

FIGS. 2 and 3 show a first embodiment of an output stage of the proposed arrangement. The output stage in this embodiment is constructed as a Wolfrom gear unit 6. The sun wheel 7 of the Wolfrom gear unit is connected to the drive shaft 5, not shown in more detail in FIG. 2. The sun wheel 7 engages with the smaller step wheel 8, 8A of every double planet. At the same time, the smaller step wheels 8, 8A of the double planets mesh respectively with the fixed ring gear 9 of the Wolfrom gear unit 6. The larger step wheels 10, 10A, 10B, 10C of every double planet which are respectively connected to the smaller step wheels 8, 8A and form a common rotational axis engage with the wheel hub 11 of the vehicle wheel to be driven and form the output. The wheel bearing is located between the spur gear unit 3 and output stage.

As can be seen particularly from FIG. 3, the Wolfrom gear unit 6 comprises, for example, four double planets which are arranged in the interior of the wheel hub 11 of the vehicle wheel to be driven.

FIG. 4 shows another embodiment of the output stage of the arrangement according to the present invention in which a two-stage planetary gear unit 12 driven by the spur gear unit as drive stage is provided as output stage.

The two-stage planetary gear unit 12 comprises a sun wheel 13 of the first stage which is connected to the central drive shaft 5, not shown in more detail in FIG. 4. The sun wheel 13 meshes with the planet gears 14, 14A of the first stage which simultaneously engage with the fixed ring gear 15 of the planetary gear unit 12. The planet carrier 16 of the planet gears 14, 14A of the first stage is connected to the sun wheel 17 of the second stage and forms a common structural component part with it. The sun wheel 17 engages with the planet gears 18, 18A of the second stage. The planet gears 18, 18A of the second stage likewise mesh with the fixed ring gear 15. The planet carrier or the arm 19 of the planet gears 18, 18A of the second stage is connected to the wheel hub 11 of the vehicle wheel to be driven and, together with this, forms the output.

Other types of gear units, for example, a Ravigneaux gear unit or the like, can also be used as output stage in the proposed arrangement. In sum, a drive axle 1 with integrated drive motors is realized for every vehicle wheel providing a maximum installation space for the drive motors owing to the small dimensions of the drive stage of every arrangement.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. An arrangement for driving a vehicle wheel comprising:
a drive stage and an output stage;
a drive axle;
at least one drive motor integrated into said drive axle and connected to said drive stage, said drive stage coupled with said output stage on a wheel hub side; and said drive stage formed by a spur gear and said output stage formed by a planetary drive.

12. The arrangement according to claim 11, wherein said spur gear comprises a one-stage spur gear unit, said spur gear unit connected on the drive side to an output shaft of said drive motor and on the output side to a drive shaft for said planetary drive.

13. The arrangement according to claim 11, wherein said planetary drive is a Wolfrom gear unit.

14. The arrangement according to claim 13, wherein said Wolfrom gear unit comprises a sun wheel, at least one double planet having smaller step wheels and larger step wheels, a fixed ring gear and a larger step wheel; wherein said sun wheel of said Wolfrom gear unit is connected to a drive shaft of said drive stage and engages with said smaller step wheel of each double planet of said Wolfrom gear unit; wherein each smaller step wheel meshes with said fixed ring gear of said Wolfrom gear unit; and wherein said larger step wheel of every double planet of said Wolfrom gear unit meshes with said wheel hub of the vehicle wheel to be driven.

15. The arrangement according to claim 11, wherein said planetary drive is a two-stage planetary gear unit.

16. The arrangement according to claim 15, wherein said two-stage planetary gear unit comprises
a first stage including a first sun wheel;
first planetary wheels and a first planet carrier;
a fixed ring gear;
a second stage including a second sun wheel, second planet wheels,
a second planet carrier;
said vehicle wheel comprising a wheel hub;
wherein said first sun wheel of said two-stage planetary gear unit is connected to a drive shaft of said drive stage and engages with said first planet gears of said first stage; said first planet gears meshing with said fixed ring gear of said planetary gear unit;
wherein said first planet carrier of said first planet gears of said first planet carrier of said first planet gears of said first stage is connected to said second sun wheel of said second stage; said second sun wheel meshing with said second planet gears of said second stage and said second planet gears engaging with said fixed ring gear; and wherein said second planet gear carrier of said second planet gears of said second stage is connected to said wheel hub of the vehicle wheel to be driven.

17. The arrangement according to claim 16, wherein said first planet carrier of said first stage forms a common constructional unit with said sun wheel of said second stage.

18. The arrangement according to claim 16, wherein said second planet carrier of said second stage forms a common constructional unit with said wheel hub.

19. The arrangement according to claim 11, wherein said planetary drive is a Ravigneaux gear unit.

20. The arrangement according to claim 11, wherein said spur gear unit comprises two spur gears; and wherein each spur gear has no bearing support on one side.

21. The arrangement according to claim 17, wherein said second planet carrier of said second stage forms a common constructional unit with said wheel hub.

22. The arrangement according to claim 11, wherein the vehicle wheel is the wheel of a bus.

23. The arrangement according to claim 22, wherein the bus is a low floor bus.

24. The arrangement according to claim 11, wherein a single drive motor is integrated into said drive axle.
